(19) United States
(12) Patent Application Publication
(10) Pub. No.: US 2021/0055903 A1
(43) Pub. Date: Feb. 25, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Shigeru TANABE, Kanagawa (JP)

(73) Assignee: FUJI XEROX CO., LTD., Tokyo (JP)

(21) Appl. No.: 16/751,451

(22) Filed: Jan. 24, 2020

(30) Foreign Application Priority Data
Aug. 23, 2019 (JP) 2019-152838

(51) Int. Cl. G06F 3/14; G06F 3/0481; G06F 3/0482; G06F 3/0485

(52) U.S. Cl. CPC G06F 3/1407; G06F 3/0485; G06F 3/0482; G06F 3/04817

(57) ABSTRACT

An information processing apparatus includes a display controller. When a first icon is selected, the display controller controls a display device to display a second icon for displaying a status of a processing corresponding to the first icon, in an area of the first icon.

### CROSS-REFERENCE TO RELATED APPLICATION(S)

This application is based on and claims priority under 35 USC 119 from Japanese Patent Application No. 2019-152838 filed on Aug. 23, 2019.

### BACKGROUND

### (i) Technical Field

The present invention relates to an information processing apparatus and a non-transitory computer readable medium.

### (ii) Related Art

JP-A-2012-248102 discloses a device that includes: a screen information storage unit that stores list screen information including an icon location, an icon image, identification information of an application, and identification information of a macro, for an icon for calling the application and the macro in which operation settings of the application are registered; a screen control unit that acquires status information of an application whose job status has changed from stand-by to execution, outputs the identification information, and performs a screen update request; a screen creation unit that updates a display form of an icon of the application indicated by the acquired identification information to a display form different from icons of other applications, on an application list screen created based on the list screen information, when receiving the screen update request; and a display unit that displays the list screen including the updated icon so that a user may easily grasp whether applications of icons displayed on the application list screen are being executed.

### SUMMARY

In a configuration where control for a device, such as an instruction for processing execution or an instruction of opening a screen on which various settings are made is executed by selecting an icon displayed on a display screen, in order to check a status of the processing instructed to be executed, it is necessary to search for an icon for displaying the processing status, from various icons. Aspects of non-limiting embodiments of the present disclosure relate to an information processing apparatus and an a non-transitory computer readable medium, in which when a first icon is selected, a time for searching for a second icon for displaying a status of a processing corresponding to the first icon may be reduced as compared to a case where the second icon present at a different location from the first icon is selected.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a display controller. When a first icon is selected, the display controller controls a display device to display a second icon for displaying a status of a processing corresponding to the first icon, in an area of the first icon.

### BRIEF DESCRIPTION OF THE DRAWINGS

Exemplary embodiment(s) of the present disclosure will be described in detail based on the following figures, wherein:

FIG. 1 is a conceptual module configuration diagram on a configuration example of an exemplary embodiment;

FIG. 2 is an explanatory view illustrating a system configuration example using the exemplary embodiment;

FIG. 3 is an explanatory view illustrating an example of a status transition diagram in an image processing apparatus;

FIG. 4 is an explanatory view illustrating a data structure example of a setting table;

FIG. 5 is an explanatory view illustrating a data structure example of an icon management table;

FIGS. 6A to 6D are explanatory views illustrating a transition example of a screen in the related art;

FIGS. 7A to 7E are explanatory views illustrating a transition example of a screen in the exemplary embodiment;

FIG. 8 is a flow chart illustrating a processing example by the exemplary embodiment;

FIGS. 9A to 9C are explanatory views illustrating the processing example by the exemplary embodiment;

FIG. 10 is an explanatory view illustrating a data structure example of a processing status check icon function table;

FIG. 11 is an explanatory view illustrating a data structure example of a setting table;

FIG. 12 is an explanatory view illustrating an example of a status transition diagram in the image processing apparatus;

FIG. 13 is an explanatory view illustrating a data structure example of an icon management table;

FIG. 14 is an explanatory view illustrating a data structure example of an application management table;

FIG. 15 is an explanatory view illustrating a data structure example of a processing status check icon function table; and

FIG. 16 is a block diagram illustrating a hardware configuration example of a computer that implements the exemplary embodiment.

### DETAILED DESCRIPTION

Hereinafter, descriptions will be made on examples of an exemplary embodiment of the present disclosure with reference to drawings.

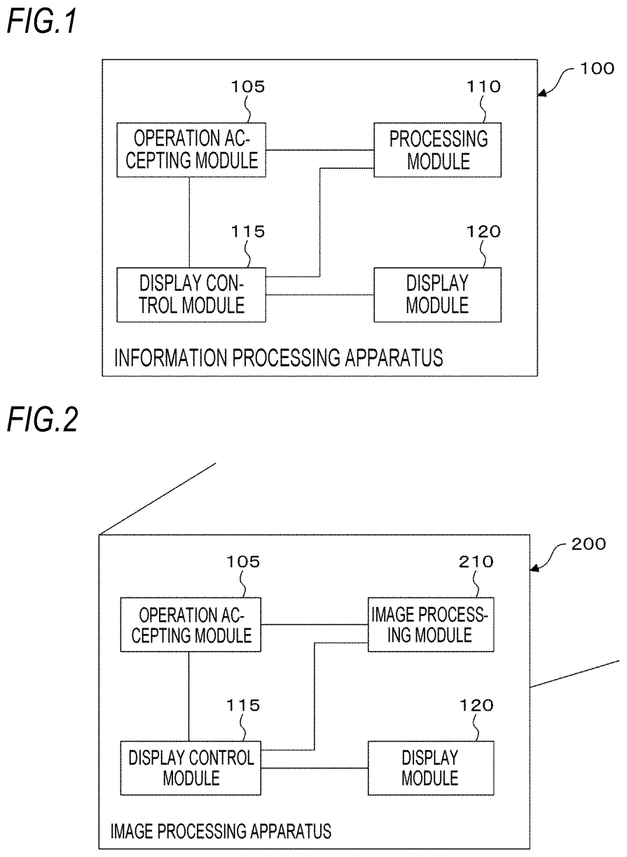

FIG. 1 illustrates a conceptual module configuration diagram on a configuration example of the exemplary embodiment.

A module generally refers to a logically separable component such as software (including a computer program as an interpretation of “software”) or hardware. Accordingly, the module in the exemplary embodiment refers to not only a module in the computer program, but also a module in a hardware configuration. Therefore, the exemplary embodiment also describes a computer program (e.g., a program causing a computer to execute respective procedures, a program causing a computer to function as respective units, and a program causing a computer to implement respective functions), a system and a method, which are allowed to serve as these modules. Meanwhile, for the sake of convenience of explanation, “to store”, “to be stored”, and equivalent wordings thereof are used. However, when the exemplary embodiment relates to a computer program, these wordings mean that the computer program is stored in a storage device, or is controlled to be stored in the storage device. The modules may correspond to functions in a one-to-one relationship. Meanwhile, in implementation, one module may be implemented by one program, plural modules may be implemented by one program, and conversely, one module may be implemented by plural programs. The plural modules may be executed by one computer, or one module may be executed by plural computers, that is, by computers in a distributed or parallel environment. One module may include another module. Hereinafter, “connection” is used for the case of not only a physical connection, but also a logical connection (e.g., a data exchange, an instruction, a reference relationship between data, a login, and the like). “Predetermined” indicates that things are determined prior to a target process, and is used with a meaning that things are determined in accordance with a situation/state at that time, or in accordance with a situation/state until then as long as a target process is not yet performed before a process according to the exemplary embodiment is started, or even after the process according to the exemplary embodiment is started. When there are plural “predetermined values”, the values may be different from each other, or two or more values (of course, “two or more values” include all values) may be the same. The statement “to carry out B when A” is used with meaning that “it is determined if it is A, and when it is determined to be A, B is carried out”. Meanwhile, this excludes a case where it is not necessary to determine if it is A. Enumeration of things such as “A, B, and C” indicates exemplary enumeration unless otherwise noted, which includes a case where only one is selected (e.g., only A).

A system or an apparatus includes not only a configuration where plural computers, hardware, apparatuses and the like are connected via a communication unit such as a network (the “network” includes a one-to-one correspondence communication connection), but also the case of implementation by one computer, one hardware, one apparatus and the like. An “apparatus” and a “system” are used as synonymous terms. Of course, the “system” does not include a thing that is merely a social “structure” (that is, a social system) as an artificial arrangement.

In each process by each module or in each of plural processes in a case where the plural processes are performed in the module, target information is read from a storage device, and a process result is written in the storage device after the process is performed. Accordingly, in some cases, reading from a storage device prior to a process, and writing to the storage device after the process may be omitted in description. Here, a storage device may include a hard disk drive, a random access memory (RAM), an external storage medium, a storage device via a communication line, a register within a central processing unit (CPU) or the like.

An information processing apparatus 100 of the exemplary embodiment has a user interface function, and includes an operation accepting module 105, a processing module 110, a display control module 115, and a display module 120 as illustrated in the example of FIG. 1.

Icons are targeted as objects of a user interface. Here, an icon is an object displayed in a user selectable manner and is represented by a character, a symbol, a figure, an image, or the like. Otherwise, the icon may be a combination of a shape, a pattern, a color, dynamic change, blinking, or the like. Therefore, the icon may be an object composed of only characters such as “Start” or “Stop”. The shape includes the shape of the icon itself, such as a triangle, a rectangle, a circle or the like. Examples of the dynamic change include flash and animation. Examples of a changing target in blinking include whether to blink, a period in which blinking is performed, and a blinking interval.

The operation accepting module 105 is connected to the processing module 110 and the display control module 115. The operation accepting module 105 accepts a user operation. The operation accepting module 105 may be, for example, a touch screen having a function of the display module 120. Otherwise, a keyboard, mechanical buttons and the like may be provided. The mechanical buttons include what are called hard keys.

The display module 120 is connected to the display control module 115. The display module 120 is a display device such as a liquid crystal display or an organic EL display, and displays icons or the like according to the control by the display control module 115. As described above, the display module 120 may be a touch screen having a function of the operation accepting module 105. In some cases, icons on the touch screen may be called soft keys.

The processing module 110 is connected to the operation accepting module 105 and the display control module 115. The processing module 110 performs a processing according to a selection operation by a user on an icon. Here, the processing includes what is called a job.

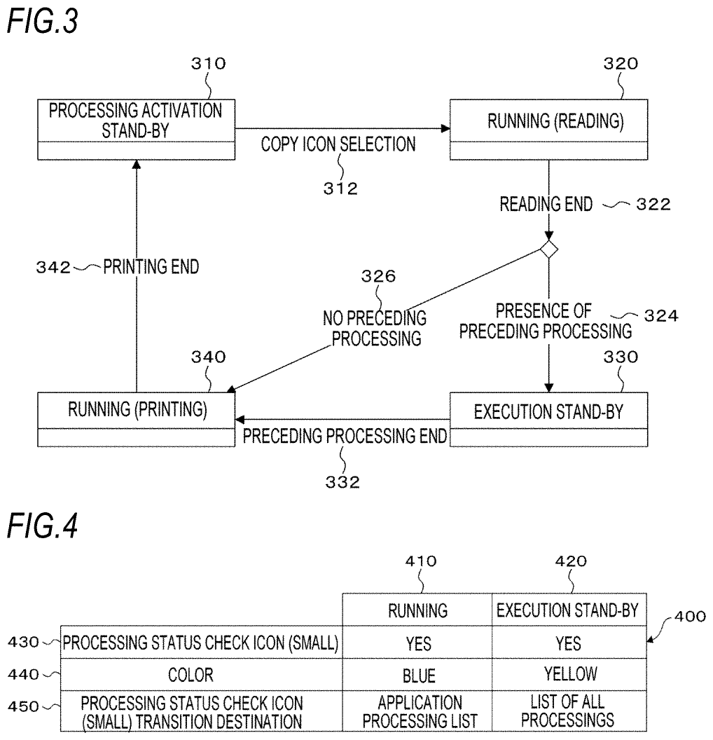

The processing module 110 may be embedded in the information processing apparatus 100 or may be present in an external device. In the former case, the information processing apparatus 100 itself performs not only a user interface function, but also a processing according to an operation on the user interface. This corresponds to an image processing apparatus 200 or the like to be described below with reference to the example in FIG. 2. The latter case corresponds to a case where there is a device connected to the information processing apparatus 100 through a communication line, and the information processing apparatus 100 has a user interface function of the device so as to cause the device to perform a processing. For example, a printer, a TV or the like corresponds to the device, and a smartphone or the like that operates the device corresponds to the information processing apparatus 100.

The display control module 115 is connected to the operation accepting module 105, the processing module 110, and the display module 120. When a first icon is selected, the display control module 115 controls the display module 120 to display a second icon for displaying the status of a processing corresponding to the first icon, in an area of the first icon.

Here, a display location of “the second icon” only has to be present within the area of the already selected first icon. For example, the second icon smaller than the first icon may be displayed in an overlapping manner, in a partial area of the first icon, or the second icon having the same size as the first icon may be displayed in an overlapping manner, on the first icon. More specifically, the former corresponds to so-called badge display, and the latter corresponds to changing the first icon into the second icon. Displaying the first icon and the second icon in an overlapping manner may be overwriting the second icon on the first icon, displaying pixels of the first icon and the second icon through a logical operation (for example, a logical sum) or the like. In the former, the second icon only has to be displayed in the partial area of the area of the first icon. That is, the area of the second icon needs not completely fit within the area of the first icon. That is, even if a partial area of the second icon is not displayed in the area of the first icon, when the other area of the second icon is displayed in the area of the first icon, it can be said that the second icon is displayed in the area of the first icon.

“The processing corresponding to the first icon” is a processing associated with the first icon, and is specifically, a processing started when the first icon is selected.

Then, “display the status of the processing corresponding to the first icon” is displaying the status of the processing started when the first icon is selected. This is a display that allows the user to check the status of the processing corresponding to the first icon, and specifically corresponds to displaying a so-called job status or the like.

When the processing corresponding to the first icon is in a stand-by state after the first icon is selected and the second icon is selected, the display control module 115 may perform control to display a list of processings the device has.

Here, “the processings the device has” include a processing that is accepted by the device and has not been finished at least at that time. Specifically, the processings include a processing being executed by the device, a waiting processing, and the like. A processing that has already been finished at that time may be included.

When the processing corresponding to the first icon is in a stand-by state after the first icon is selected, the display control module 115 may perform control so as not to display the second icon.

The display control module 115 may perform control such that a display form of the second icon when the processing corresponding to the first icon is running after the first icon is selected is different from that when the processing is in a stand-by state after the first icon is selected. That is, any display form may be employed that allows the user to distinguish between “when the processing corresponding to the first icon is running” and “when the processing corresponding to the first icon is in a stand-by state”.

Here, the “display form” includes a shape, a pattern, and a color of the second icon or a combination thereof, or dynamic changing thereof. Examples of the “dynamic change” include flash and animation.

The display control module 115 may perform control to display the second icon in the area of a third icon corresponding to another processing having the same function as the function of the processing corresponding to the first icon as well as the area of the first icon.

When the second icon is selected, the display control module 115 may perform control to display a list of processings that use the same function as the processing corresponding to the first icon.

The display control module 115 may change contents to be displayed when the second icon is selected, according to a method of selecting the second icon.

Here, “the method of selecting the second icon” refers to movement of a finger or a pen in selecting the second icon displayed on the display device, and examples thereof include tap, double tap, and long tap.

The display control module 115 may change contents to be displayed when the second icon is selected, according to a processing status.

Here, the “processing status” means that the processing corresponding to the first icon is in one of an activation stand-by state, a running state, and a stand-by state. The activation stand-by means that the processing is in a stand-by state because another processing that is different from the corresponding processing but uses the same function is running. The stand-by means that there is already the same processing, and thus the corresponding processing is waiting for its turn.

When a predetermined key is selected, the display control module 115 may perform control of returning to a location where the first icon is displayed.

Here, “the predetermined key” is a key for returning to an initial screen. This corresponds to, for example, a key called a home key. This key may be a hard key.

The first icon may correspond to a processing in which a predetermined value is set by the user.

In this case, the display control module 115 may perform control to display the second icon in the area of the third icon as a source of the processing in addition to the area of the first icon.

Here, “the third icon” is an icon preset in the device, and corresponds to a processing for which value setting is required before execution. This corresponds to, for example, a copy icon.

The display control module 115 may preferentially display the first icon on which the second icon is displayed, on a display screen.

Here, “preferentially display the first icon on which the second icon is displayed, on the display screen” means that the first icon on which the second icon is displayed is displayed on a place with a higher display priority when the first icon on which the second icon is displayed, and an icon on which the second icon is not displayed are displayed in a mixed manner.

When there are plural first icons, the display control module 115 may perform control such that the first icons are sorted and displayed according to the statuses of the processings corresponding to the first icons.

Here, “the first icons are sorted according to the processing statuses” means that information to be sorted varies depending on whether the processing status is activation stand-by, running, or stand-by. For example, in the case of running, the sorting may be performed in the activation order, and in the case of execution stand-by, the sorting may be performed in a processing scheduling order.

FIG. 2 is an explanatory view illustrating a system configuration example using the exemplary embodiment. This illustrates a specific example of the information processing apparatus 100, and illustrates an example in the case of implementation as the image processing apparatus 200.

The image processing apparatus 200 includes the operation accepting module 105, an image processing module 210, the display control module 115, and the display module 120.

The same reference numeral is attached to a portion of the same kind as that in the exemplary embodiment illustrated in the example of FIG. 1, and redundant descriptions thereof will be omitted.

The operation accepting module 105 is connected to the image processing module 210, and the display control module 115. The display control module 115 is connected to the operation accepting module 105, the image processing module 210, and the display module 120. The display module 120 is connected to the display control module 115.

The image processing module 210 is connected to the operation accepting module 105, and the display control module 115. The image processing module 210 indicates a specific example of the processing module 110, and performs a processing according to an operation accepted by the operation accepting module 105. For example, when a “copy” icon as an example of the first icon is selected, a copy processing is performed. Then, the image processing module 210 notifies the display control module 115 of the status of the copy processing according to a request from the display control module 115.

<1>

When an icon is selected and a processing corresponding to the icon is activated, a state of “running”, “execution stand-by”, or “processing activation stand-by” is made. “Running” includes “reading”, “outputting”, “communicating”, “transferring” and the like.

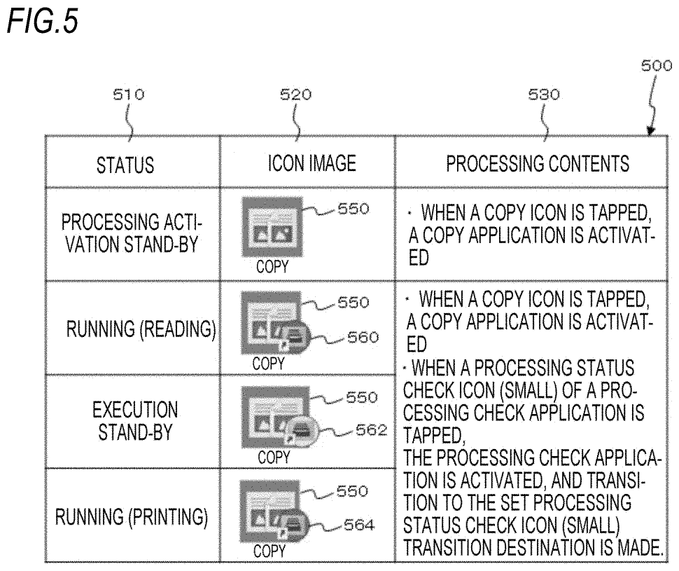

FIG. 3 is an explanatory view illustrating an example of a status transition diagram of a copy processing in the image processing apparatus 200.

When there is a copy icon selection 312, the status shifts from a processing activation stand-by state 310 to a running (reading) state 320. In the example of FIG. 3, there is a description of “from the status of the processing activation stand-by state 310 when there is the copy icon selection 312”. Specifically, when the copy icon is selected by the user, a copy application is activated and displaying according to the copy application is performed. Then, a job activation parameter is set by the copy application and a job start button is selected by the user so that a copy job is activated and the status shifts to the running (reading) state 320.

At reading end 322, the status diverges from the running (reading) state 320 into presence of a preceding processing 324 or no preceding processing 326 according to presence or absence of a preceding processing. In the case of the presence of a preceding processing 324, the status shifts to an execution stand-by state 330, and in the case of no preceding processing 326, the status shifts to a running (printing) state 340. Here, the preceding processing refers to a processing that is instructed to start before the copy processing, and includes a print processing. This may be, for example, a print processing or a facsimile reception processing, which is accepted before the current copy processing.

At preceding processing end 332, the status shifts from the execution stand-by state 330 to the running (printing) state 340.

At printing end 342, the status shifts from the running (printing) state 340 to the processing activation stand-by state 310.

After the copy icon selection 312, when the user wants to know what state the copy processing is in, he or she selects a processing status check icon (the processing status check icon is an example of the second icon). Then, he or she may know whether the copy processing is in the running (reading) state 320, the execution stand-by state 330, or the running (printing) state 340.

<2>

A processing corresponding to the processing status check icon (hereinafter, also referred to as a processing check application) provides the following functions.

a) displaying a list of all processings.

b) displaying details of each processing.

c) displaying a list of processings through filtering. “Through filtering” means that a list of only processings satisfying a certain specific condition is generated. For example, those are as follows.

c1) displaying a processing list of each activated processing.

c2) displaying a processing list for each used resource. For example, the image processing apparatus 200 includes the followings.
A processing list for print (a list of processings using an image forming apparatus)
A processing list for call (a list of processings using a telephone line)
A processing list for communication (a list of processings using a communication line)

d) cancelling or temporarily stopping a processing, or changing parameters

<3>

The processing status check icon displayed on a menu screen is displayed in a display area of an icon whose processing is started (in the above described example, the copy icon). Accordingly, since the processing status check icon is displayed at the same location as the icon immediately after the icon is selected, the user does not need to move to another menu screen or to perform an operation such as scrolling in order to search for the processing status check icon. It is desirable that the processing status check icon with a smaller size than the selected icon is displayed overlapping the icon. Specifically, the processing status check icon is displayed in the batch display form for the icon.

<4>

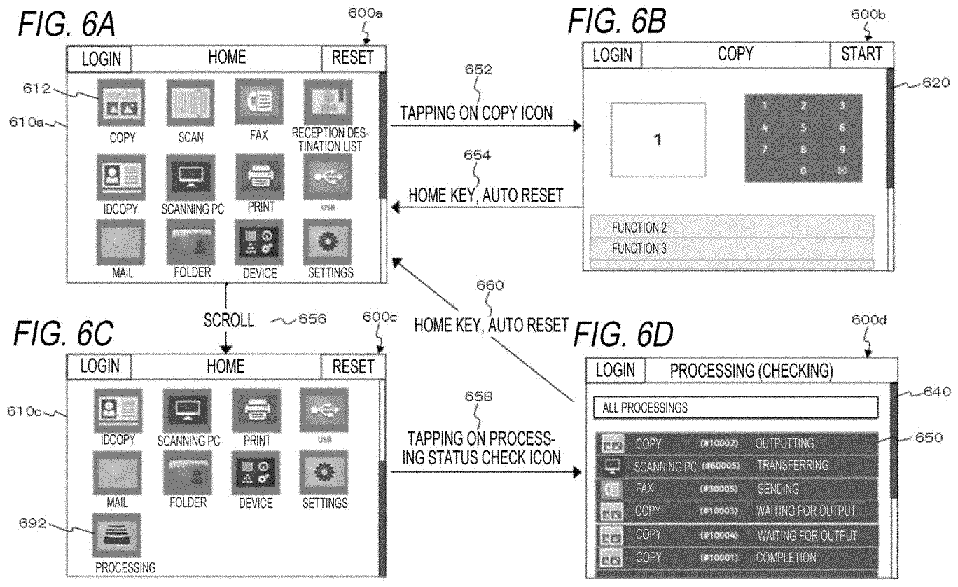

The processing check application may perform setting illustrated in a setting table 400 according to the processing status. FIG. 4 is an explanatory view illustrating a data structure example of the setting table 400.

The setting table 400 illustrated in the example of FIG. 4 illustrates the followings. In the above described example of FIG. 3, in the case of the running (reading) state 320 and the running (printing) state 340, running 410 is applied, and in the case of the execution stand-by state 330, execution stand-by 420 is applied.

A processing status check icon (small) 430 is “yes” in the running 410, and is “yes” in the execution stand-by 420.

A color 440 is “blue” in the running 410, and is “yellow” in the execution stand-by 420.

A processing status check icon (small) transition destination 450 is “application processing list” in the running 410, and is “list of all processings” in the execution stand-by 420. The processing status check icon (small) transition destination 450 indicates the behavior when a processing status check icon (small) is selected.

That is, in a case where a certain icon is selected, the running 410 in the setting table 400 indicates that when an application corresponding to the icon is running, the processing status check icon (small) is displayed overlapping the selected icon, and the color of the processing status check icon (small) is blue, and when the processing status check icon (small) is selected, a processing list of the application corresponding to the icon is displayed.

In a case where a certain icon is selected, the execution stand-by 420 in the setting table 400 indicates that when an application corresponding to the icon is in an execution stand-by state, the processing status check icon (small) is displayed overlapping the selected icon, and the color of the processing status check icon (small) is yellow, and when the processing status check icon (small) is selected, a current list of all processings is displayed.

The processing status check icon (small) may be implemented as a shortcut of the processing check application corresponding to the processing status check icon. That is, selecting the processing status check icon (small) is substantially the same as selecting the processing status check icon.

Unless it is necessary, it is possible not to display the processing status check icon (small). Specifically, by storing “no” in a cell where the processing status check icon (small) 430 and the execution stand-by 420 intersect, it is possible not to display the processing status check icon (small) in the case of execution stand-by.

The color of the processing status check icon (small) may be adjusted by the color 440 so that running and execution stand-by are identifiable.

As described above in <2>, the processing check application has various functions. According to the processing status check icon (small) transition destination 450, it is possible to set contents to be displayed when the processing status check icon (small) is tapped (tapping is an example of selecting). Specifically, it is possible to set which of functions a) to d) described in <2> is to be performed.

<5>

In the case of, for example, a copy processing, through settings of the setting table 400 in <4> described above, icons illustrated in an icon management table 500 are obtained.

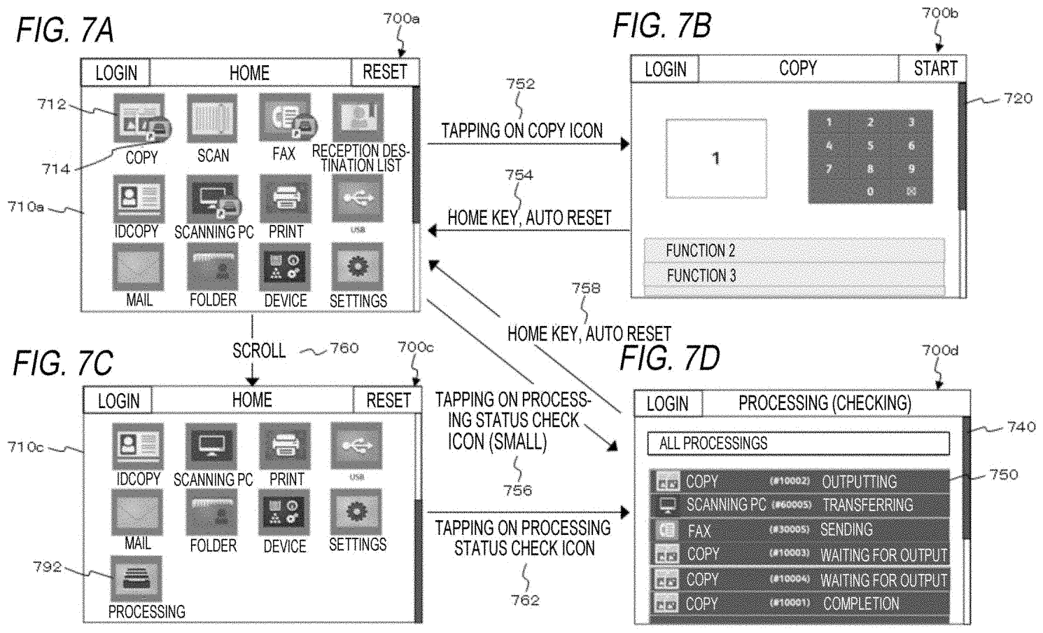

FIG. 5 is an explanatory view illustrating a data structure example of the icon management table 500. The icon management table 500 includes a status column 510, an icon image column 520, and a processing content column 530. The status column 510 stores a status. The icon image column 520 stores an icon image. The processing content column 530 stores processing contents.

The first row of the icon management table 500, in relation to the processing activation stand-by state 310, displays a copy icon 550, and indicates that “a copy application is activated when the copy icon 550 is tapped”.

The second row of the icon management table 500, in relation to the running (reading) state 320, displays the copy icon 550 and a processing status check icon (small, blue) 560, and indicates that “the copy application is activated when the copy icon 550 is tapped”, and “when the processing status check icon (small, blue) 560 of a processing check application is tapped, the processing check application is activated, and transition to the processing status check icon (small) transition destination set in the setting table 400 is made”.

The third row of the icon management table 500, in relation to the execution stand-by state 330, displays the copy icon 550 and a processing status check icon (small, yellow) 562, and indicates that “the copy application is activated when the copy icon 550 is tapped”, and “when the processing status check icon (small, yellow) 562 of the processing check application is tapped, the processing check application is activated, and transition to the processing status check icon (small) transition destination set in the setting table 400 is made”.

The fourth row of the icon management table 500, in relation to the running (printing) state 340, displays the copy icon 550 and a processing status check icon (small, blue) 564, and indicates that “the copy application is activated when the copy icon 550 is tapped”, and “when the processing status check icon (small, blue) 564 of the processing check application is tapped, the processing check application is activated, and transition to the processing status check icon (small) transition destination set in the setting table 400 is made”.

<6>

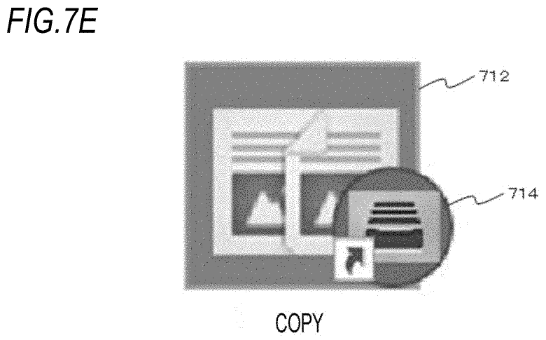

FIGS. 6A to 6D are explanatory views illustrating a transition example of a screen in the related art. These illustrate a display example of a screen when the exemplary embodiment is not used.

In a configuration where an icon is displayed on a display screen instead of a hard key, and a processing is started when the icon is selected, in order to display a processing status, an icon for displaying the status has to be selected. Thus, it is necessary to search for “the icon for displaying the status” which is present at a different location from the icon for executing the processing. For example, if there is a hard key for displaying the processing status, when the user wants to check the processing status, he or she may select the hard key. However, in a case where there are icons as soft keys, if there are many icons, scrolling or the like is necessary on the display screen or it is necessary to perform transition to a menu screen where the icon for displaying the processing status is present.

Specifically, there are following examples.

In the example of FIG. 6A, on a screen 600a, an icon display area 610a is displayed. An icon group such as a copy icon 612 is displayed in the icon display area 610a.

When there is tapping 652 on the copy icon 612, the status of the screen 600a illustrated in the example of FIG. 6A shifts to the status of a screen 600b illustrated in the example of FIG. 6B.

In the example of FIG. 6B, a copy operation area 620 is displayed on the screen 600b. In the copy operation area 620, an object of a user interface for performing setting for copying, for example, setting of the number of copies is displayed. Then, when a “start” icon in the upper right is selected, a copy processing is started.

When auto reset 654 (a home key) is performed, the status of the screen 600b illustrated in the example of FIG. 6B shifts to the status of the screen 600a illustrated in the example of FIG. 6B.

When scroll 656 is operated, the status of the screen 600a illustrated in the example of FIG. 6A shifts to the status of a screen 600c illustrated in the example of FIG. 6C.

An icon display area 610c is displayed on the screen 600c illustrated in the example of FIG. 6C. Icons such as a processing status check icon 692 are displayed in the icon display area 610c.

When there is tapping 658 on the processing status check icon 692, the status of the screen 600c illustrated in the example of FIG. 6C shifts to the status of a screen 600d illustrated in the example of FIG. 6D.

A processing status display area 640 is displayed on the screen 600d illustrated in the example of FIG. 6D. A processing status list 650 is displayed within the processing status display area 640. For example, in FIG. 6D, “copy (#10002) outputting” in the first row, “scanning PC (#60005) transferring” in the second row, “fax (#30005) sending” in the third row, “copy (#10003) waiting for output” in the fourth row, “copy (#10004) waiting for output” in the fifth row, and “copy (#10001) completion” in the sixth row are displayed. These indicate a processing name, a processing number, and a processing status of each processing.

Then, when auto reset 660 (a home key) is performed, the status of the screen 600d illustrated in the example of FIG. 6D shifts to the status of the screen 600a illustrated in the example of FIG. 6A.

As described above, when the copy icon 612 is tapped, and the copy processing is started, if the user wants to display the status of the copy processing, he or she needs to operate the scroll 656, and to search for and select the processing status check icon 692.

<7>

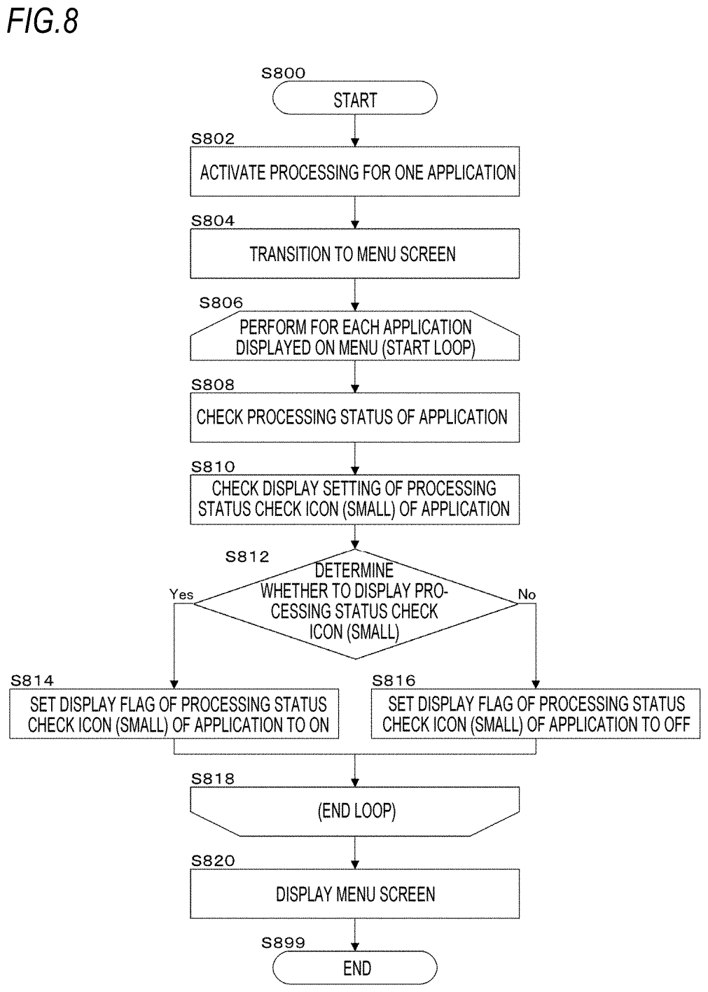

FIGS. 7A to 7E are explanatory views illustrating a transition example of a screen in the exemplary embodiment.

A screen 700b illustrated in the example of FIG. 7B, and a screen 700d illustrated in the example of FIG. 7D are the same as the screen 600b illustrated in the example of FIG. 6B and the screen 600d illustrated in the example of FIG. 6D, respectively.

An application of a processing status check icon (small) 714 may be implemented as a shortcut that performs an application of a processing status check icon 792.

An icon display area 710a is displayed on a screen 700a illustrated in the example of FIG. 7A. An icon group such as a copy icon 712 is displayed in the icon display area 710a.

When there is tapping 752 on the copy icon 712, the status of the screen 700a illustrated in the example of FIG. 7A shifts to the status of the screen 700b illustrated in the example of FIG. 7B.

When there is tapping 756 on the processing status check icon (small) 714, the status of the screen 700a illustrated in the example of FIG. 7A shifts to the status of the screen 700d illustrated in the example of FIG. 7D.

When there is scrolling 760, the status of the screen 700a illustrated in the example of FIG. 7A shifts to the status of a screen 700c illustrated in the example of FIG. 7C.

A copy operation area 720 is displayed on the screen 700b illustrated in the example of FIG. 7B.

When auto reset 754 (a home key) is performed, the status of the screen 700b illustrated in the example of FIG. 7B shifts to the status of the screen 700a illustrated in the example of FIG. 7A.

An icon display area 710c is displayed on the screen 700c illustrated in the example of FIG. 7C. An icon group such as the processing status check icon 792 is displayed in the icon display area 710c.

When there is tapping 762 on the processing status check icon 792, the status of the screen 700c illustrated in the example of FIG. 7C shifts to the status of the screen 700d illustrated in the example of FIG. 7D.

A processing status display area 740 is displayed on the screen 700d illustrated in the example of FIG. 7D.

A processing status list 750 is displayed within the processing status display area 740. For example, in FIG. 7D, “copy (#10002) outputting” in the first row, “scanning PC (#60005) transferring” in the second row, “fax (#30005) sending” in the third row, “copy (#10003) waiting for output” in the fourth row, “copy (#10004) waiting for output” in the fifth row, and “copy (#10001) completion” in the sixth row are displayed. These indicate a processing name, a processing number, and a processing status of each processing.

Then, when auto reset 758 (a home key) is performed, the status of the screen 700d illustrated in the example of FIG. 7D shifts to the status of the screen 700a illustrated in the example of FIG. 7A.

This example is different from the example of FIGS. 6A to 6D described above in <6> in that when a processing is started, the processing status check icon (small) 714 (a shortcut of the processing status check icon 792) is displayed on an icon (the copy icon 712 in the example of FIG. 7A) of the started processing, and a processing check application is activated via the shortcut so that the processing status illustrated in the example of FIG. 7D may be checked.

In the relationship between the copy icon 712 and the processing status check icon (small) 714 on the display, as illustrated in the example of FIG. 7E, the processing status check icon (small) 714 is displayed overlapping the area where the copy icon 712 is displayed. This makes it possible to select one of the copy icon 712 and the processing status check icon (small) 714.

<8>

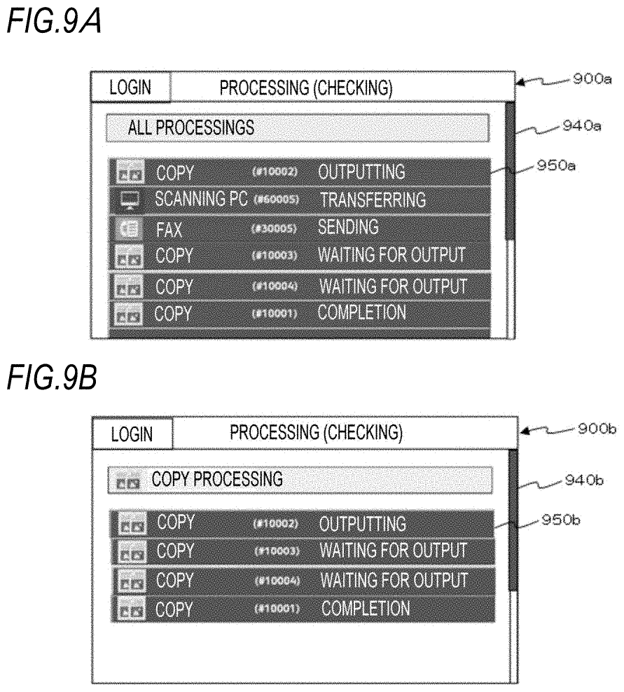

FIG. 8 is a flow chart illustrating a processing example according to the exemplary embodiment. Specifically, this relates to a processing of displaying the processing status check icon (small) 714.

In step S802, a processing for one application is activated. Specifically, this corresponds to a case where there is the tapping 752 on the copy icon 712 in the example of FIG. 7A, and the “start” icon in the upper right is selected in the example in FIG. 7B.

In step S804, transition to the menu screen is made. Specifically, when the auto reset 754 (a home key) is performed, the status illustrated in the example of FIG. 7B returns to the status the screen 700a illustrated in the example of FIG. 7A. Returning to the screen 700a illustrated in the example of FIG. 7A, as home, triggers off detection of a current job status or the like. Then, a shortcut icon may be displayed or in a case where the shortcut icon is displayed, the display may be changed.

In step S806, processings in step S808 to step S816 are performed for each application displayed on the menu.

In step S808, a processing status of an application is checked.

In step S810, the display setting of a processing status check icon (small) of the application is checked. Specifically, the setting table 400 corresponding to the application is checked.

In step S812, it is determined whether to display the processing status check icon (small). When the processing status check icon (small) is to be displayed, the process proceeds to step S814. Otherwise, the process proceeds to step S816.

In step S814, a display flag of the processing status check icon (small) of the application is set to ON.

In step S816, the display flag of the processing status check icon (small) of the application is set to OFF.

In step S818, the processings in step S808 to step S816 are repeated until performed for all applications displayed on the menu.

In step S820, the menu screen is displayed. That is, the processing status check icon (small) is displayed for the icon whose display flag of the processing status check icon (small) is ON.

<9>

A processing example in a case where the processing status check icon (small) is selected will be described.

For example, when a copy processing is started, and the processing status check icon (small) 714 displayed overlapping the copy icon 712 is selected, the transition destination of the screen changes according to setting of the processing status check icon (small) transition destination 450 in the setting table 400.

This example is described below.

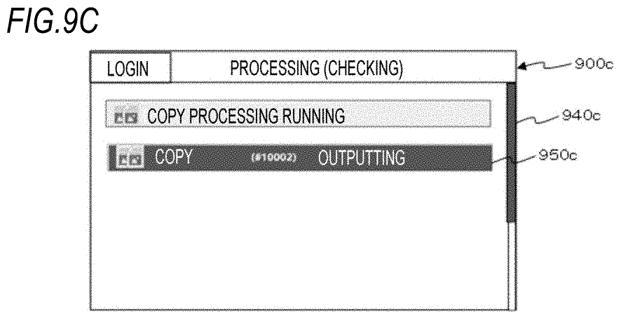

FIGS. 9A to 9C are explanatory views illustrating a processing example according to the exemplary embodiment.

In the example of FIG. 9A, a processing status display area 940a is displayed on a screen 900a.

A processing status list 950a is displayed within the processing status display area 940a. The processing status list 950a is a list of all processings. Specifically, all processings include running processings, execution stand-by processings, and completed processings. For example, in FIG. 9A, in the processing status list 950a, “copy (#10002) outputting” in the first row, “scanning PC (#60005) transferring” in the second row, “fax (#30005) sending” in the third row, “copy (#10003) waiting for output” in the fourth row, “copy (#10004) waiting for output” in the fifth row, and “copy (#10001) completion” in the sixth row are displayed. These indicate a processing name, a processing number, and a processing status of each processing.

In the example of FIG. 9B, a processing status display area 940b is displayed on a screen 900b.

A processing status list 950b is displayed within the processing status display area 940b. The processing status list 950b is a list of the copy processings. For example, in FIG. 9B, “copy (#10002) outputting” in the first row, “copy (#10003) waiting for output” in the second row, “copy (#10004) waiting for output” in the third row, and “copy (#10001) completion” in the fourth row are displayed.

In the example of FIG. 9C, a processing status display area 940c is displayed on a screen 900c.

A processing status list 950c is displayed within the processing status display area 940c. The processing status list 950c is a list of a running copy processing. For example, in FIG. 9C, “copy (#10002) outputting” is displayed in the first row.

The example in FIG. 9B and the example in FIG. 9C correspond to a case where the target is a copy processing, but, of course, the target may be other processings. For example, when a processing status check icon (small) for a fax is selected, through filtering by the fax, each of a list of fax processings and a list of a running fax processing is displayed.

A processing status check icon function table 1000 may be prepared as settings for the processing status check icon (small) transition destination 450 of the setting table 400.

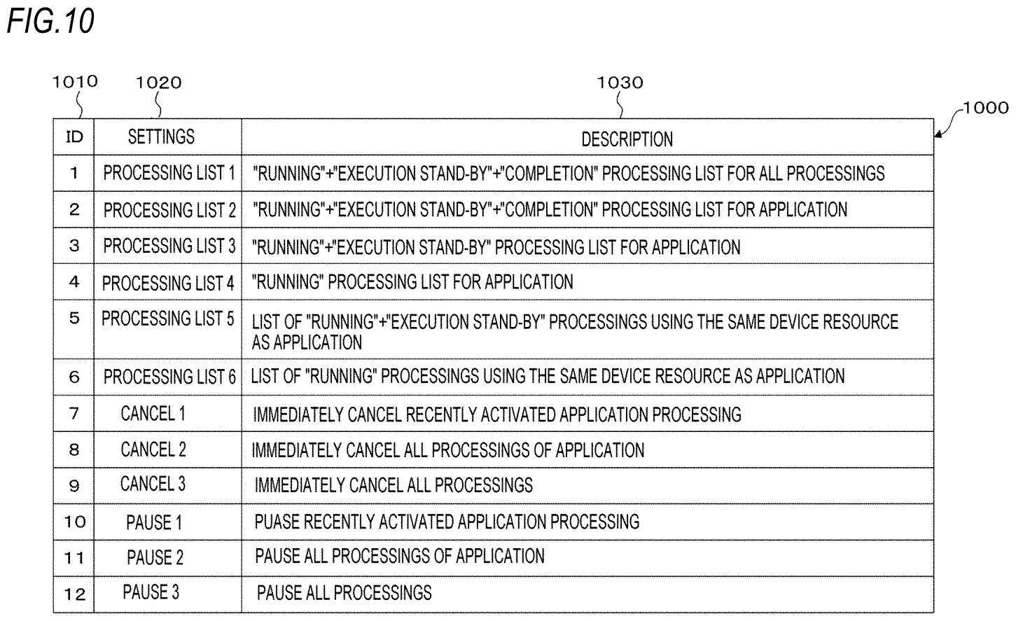

FIG. 10 is an explanatory view illustrating a data structure example of the processing status check icon function table 1000. The processing status check icon function table 1000 includes an ID column 1010, a setting column 1020, and a description column 1030. The ID column 1010 stores IDs. The setting column 1020 stores settings. The description column 1030 stores descriptions of the settings.

For example, in the processing status check icon function table 1000, the first row indicates that ID:1 is set to “processing list 1”, and the description is ““running”+“execution stand-by”+“completion” processing list for all processings”, the second row indicates that ID:2 is set to “processing list 2”, and the description is ““running”+“execution stand-by”+“completion” processing list for application”, the third row indicates that ID:3 is set to “processing list 3”, and the description is ““running”+“execution stand-by” processing list for application”, the fourth row indicates that ID:4 is set to “processing list 4”, and the description is ““running” processing list for application” the fifth row indicates that ID:5 is set to “processing list 5”, and the description is “list of “running”+“execution stand-by” processings using the same device resource as application”, the sixth row indicates that ID:6 is set to “processing list 6”, and the description is “list of “running” processings using the same device resource as application”, the seventh row indicates that ID:7 is set to “cancel 1”, and the description is “immediately cancel recently activated application processing”, the eighth row indicates that ID:8 is set to “cancel 2”, and the description is “immediately cancel all processings of application”, the ninth row indicates that ID:9 is set to “cancel 3”, and the description is “immediately cancel all processings”, the tenth row indicates that ID:10 is set to “pause 1”, and the description is “pause recently activated application processing”, the eleventh row indicates that ID:11 is set to “pause 2”, and the description is “pause all processings of application”, and the twelfth row indicates that ID:12 is set to “pause 3”, and the description is “pause all processings”.

For example, when the processing list 3 of ID:3 is set, a list of incomplete processings through filtering by a target processing is displayed. That is, this setting allows the user to check in what order his processing is scheduled.

For example, when the processing list 4 of ID:4 is set, a list of a running processing through filtering by a target processing is displayed. When immediate cancellation of a running processing is desired, the processing may be quickly found. That is, this is because when processings are cancelled, in many cases, a running processing is more urgent than an execution stand-by processing, and cancellation is often performed by looking at the output first page.

According to a method of selecting a processing status check icon (small), contents displayed when the processing status check icon (small) is selected may be varied. Specifically, settings may be made as in a setting table 1100. Here, as “a selecting method”, tapping, double tapping, and long tapping are exemplified.

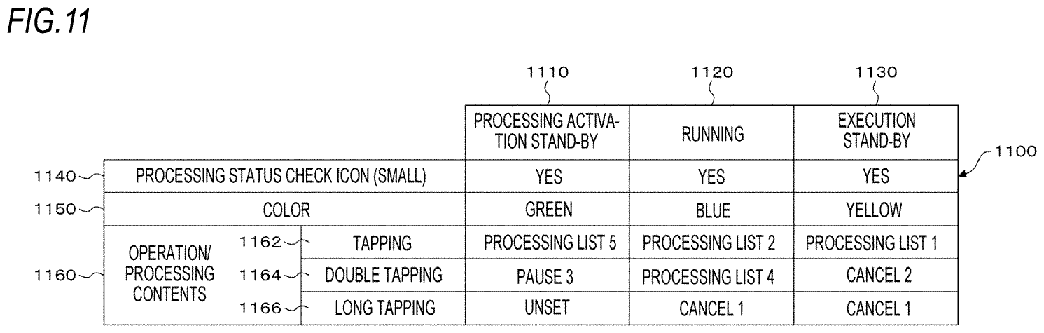

FIG. 11 is an explanatory view illustrating a data structure example of the setting table 1100. The setting table 1100 illustrated in the example of FIG. 11 indicates the followings.

A processing status check icon (small) 1140 is “yes” in processing activation stand-by 1110, is “yes” in running 1120, and is “yes” in execution stand-by 1130.

A color 1150 is “green” in the processing activation stand-by 1110, is “blue” in the running 1120, and is “yellow” in the execution stand-by 1130.

Operation/processing contents 1160 correspond to the processing status check icon (small) transition destination 450 of the setting table 400, and indicate the behavior when the processing status check icon (small) is selected.

Tapping 1162 of the operation/processing contents 1160 corresponds to “processing list 5” in the processing activation stand-by 1110, “processing list 2” in the running 1120, and “processing list 1” in the execution stand-by 1130.

Double tapping 1164 of the operation/processing contents 1160 corresponds to “pause 3” in the processing activation stand-by 1110, “processing list 4” in the running 1120, and “cancel 2” in the execution stand-by 1130.

Long tapping 1166 of the operation/processing contents 1160 corresponds to “unset” in the processing activation stand-by 1110, “cancel 1” in the running 1120, and “cancel 1” in the execution stand-by 1130.

That is, in a case where a certain icon is selected, the processing activation stand-by 1110 of the setting table 1100 indicates that when an application corresponding to the icon is in a processing activation stand-by state, the processing status check icon (small) is displayed overlapping the selected icon, and the color of the processing status check icon (small) is green, when the processing status check icon (small) is tapped, a display is made in the form of “processing list 5” defined in the processing status check icon function table 1000, when the processing status check icon (small) is double-tapped, processings are paused in the form of “pause 3” defined in the processing status check icon function table 1000, and when the processing status check icon (small) is long-tapped, there is no setting.

In a case where a certain icon is selected, the running 1120 of the setting table 1100 indicates that when an application corresponding to the icon is running, the processing status check icon (small) is displayed overlapping the selected icon, and the color of the processing status check icon (small) is blue, when the processing status check icon (small) is tapped, a display is made in the form of “processing list 2” defined in the processing status check icon function table 1000, when the processing status check icon (small) is double-tapped, a display is made in the form of “processing list 4” defined in the processing status check icon function table 1000, and when the processing status check icon (small) is long-tapped, cancellation is performed in the form of “cancel 1” defined in the processing status check icon function table 1000.

In a case where a certain icon is selected, the execution stand-by 1130 of the setting table 1100 indicates that when an application corresponding to the icon is in an execution stand-by state, the processing status check icon (small) is displayed overlapping the selected icon, and the color of the processing status check icon (small) is yellow, when the processing status check icon (small) is tapped, a display is made in the form of “processing list 1” defined in the processing status check icon function table 1000, when the processing status check icon (small) is double-tapped, cancellation is performed in the form of “cancel 2” defined in the processing status check icon function table 1000, and when the processing status check icon (small) is long-tapped, cancellation is performed in the form of “cancel 1” defined in the processing status check icon function table 1000.

When a processing status check icon (small) is displayed in an area of a copy icon, control may be performed such that the processing status check icon (small) is further displayed in an area of a print icon. The reason the processing status check icon (small) is displayed in the area of the print icon as well as in the area of the copy icon as a target is that a print processing uses the same print function as a copy processing. Accordingly, not only copy processings but also print processings have to be displayed so that the order of processings using the print function may be checked. “The same function” includes the case of the same resource. Specifically, since the print function is implemented by a print module (the print module is an example of a resource), the print function and the print module are synonymously used.

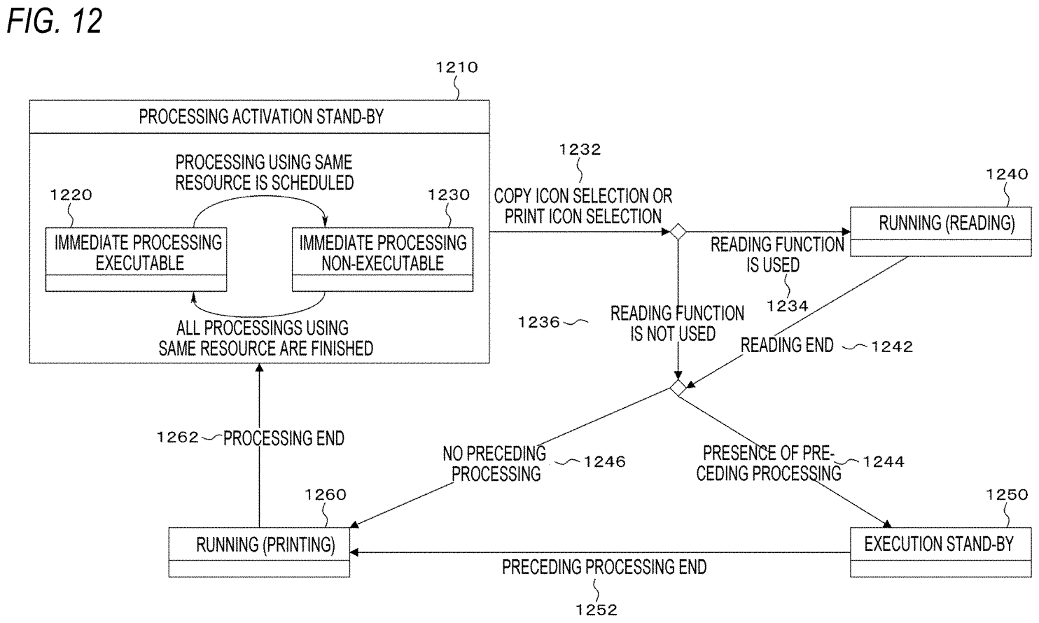

FIG. 12 is an explanatory view illustrating an example of a status transition diagram in the image processing apparatus 200. In the status transition diagram illustrated in the example of FIG. 12, the processing activation stand-by state 310 of the status transition diagram illustrated in the example of FIG. 3 is expressed including states where a processing using the same resource is present and absent.

A processing activation stand-by state 1210 includes an immediate processing executable state 1220, and an immediate processing non-executable state 1230.

When a processing using the same resource is scheduled, the immediate processing executable state 1220 shifts to the immediate processing non-executable state 1230.

When all processings using the same resource are finished, the immediate processing non-executable state 1230 shifts to the immediate processing executable state 1220.

When there is “copy icon selection or print icon selection 1232” and a reading function is used 1234, the status shifts from the processing activation stand-by state 1210 to a running (reading) state 1240. In the example of FIG. 12, there is a description of “from the status of the processing activation stand-by state 1210 when there is “the copy icon selection or print icon selection 1232”.” Specifically, when the copy icon is selected by the user, a copy application is activated and displaying according to the copy application is performed. Then, a job activation parameter is set by the copy application, and a job start button is selected by the user so that a copy job is activated, and the status shifts to the running (reading) state 1240.

When the copy icon is selected in “the copy icon selection or print icon selection 1232”, since image reading is performed, the reading function is used 1234. When the print icon is selected, since reading is unnecessary, a reading function is not used 1236.

When there is “the copy icon selection or print icon selection 1232”, and the reading function is not used 1236, in the case of presence of a preceding processing 1244, the status shifts from the processing activation stand-by state 1210 to an execution stand-by state 1250. In the example of FIG. 12, there is a description of “from the status of the processing activation stand-by state 1210 when there is “the copy icon selection or print icon selection 1232”.” Specifically, when the print icon is selected by the user, a print application is activated, and displaying according to the print application is performed. Then, a job activation parameter is set by the print application, and a print job start button is selected by the user so that a print job is activated. When the reading function is not used 1236, in the case of the presence of a preceding processing 1244, the status shifts to the execution stand-by state 1250.

When there is “the copy icon selection or print icon selection 1232” and the reading function is not used 1236, in the case of no preceding processing 1246, the status shifts from the processing activation stand-by state 1210 to a running (printing) state 1260. In the example of FIG. 12, there is a description of “from the status of the processing activation stand-by state 1210 when there is “the copy icon selection or print icon selection 1232”.” Specifically, when the print icon is selected by the user, a print application is activated, and displaying according to the print application is performed. Then, a job activation parameter is set by the print application, and the print job start button is selected by the user so that the print job is activated. When the reading function is not used 1236, in the case of no preceding processing 1246, the status shifts to the running (printing) state 1260.

At reading end 1242, the status diverges from the running (reading) state 1240 into the presence of a preceding processing 1244 or no preceding processing 1246 according to the presence or absence of a preceding processing. In the case of the presence of a preceding processing 1244, the status shifts to the execution stand-by state 1250, and in the case of no preceding processing 1246, the status shifts to the running (printing) state 1260.

At preceding processing end 1252, the status shifts from the execution stand-by state 1250 to the running (printing) state 1260.

At printing end 1262, the status shifts from the running (printing) state 1260 to the processing activation stand-by state 1210.

An icon management table 1300 may be used in association with the status transition diagram illustrated in the example of FIG. 12.

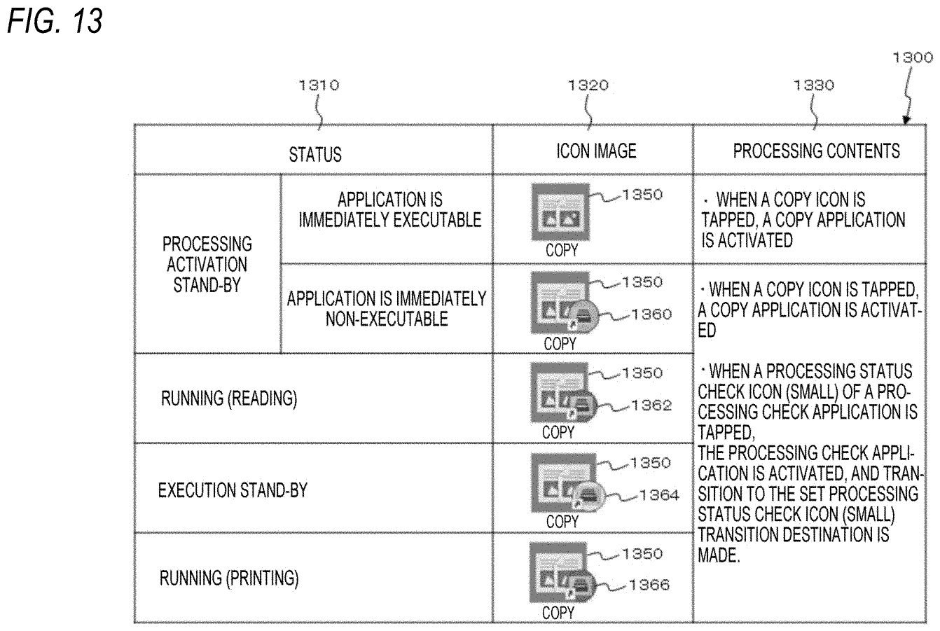

FIG. 13 is an explanatory view illustrating a data structure example of the icon management table 1300. The icon management table 1300 includes a status column 1310, an icon image column 1320, and a processing content column 1330. The status column 1310 stores a status. The icon image column 1320 stores an icon image. The processing content column 1330 stores processing contents.

The first row of the icon management table 1300, in relation to the immediate processing executable state 1220 of the processing activation stand-by state 1210, displays a copy icon 1350, and indicates that “a copy application is activated when the copy icon 1350 is tapped”.

The second row of the icon management table 1300, in relation to the immediate processing non-executable state 1230 of the processing activation stand-by state 1210, displays the copy icon 1350 and a processing status check icon (small) 1360, and indicates that “the copy application is activated when the copy icon 1350 is tapped”, and “when the processing status check icon (small) 1360 of a processing check application is tapped, the processing check application is activated, and transition to the set processing status check icon (small) transition destination is made”.

The third row of the icon management table 1300, in relation to a running (reading) state 1240, displays the copy icon 1350, and a processing status check icon (small) 1362, and indicates that “the copy application is activated when the copy icon 1350 is tapped”, and “when the processing status check icon (small) 1362 of the processing check application is tapped, the processing check application is activated, and transition to the set processing status check icon (small) transition destination is made”.

The fourth row of the icon management table 1300, in relation to the execution stand-by state 1250, displays the copy icon 1350 and a processing status check icon (small) 1364, and indicates that “the copy application is activated when the copy icon 1350 is tapped” and “when the processing status check icon (small) 1364 of the processing check application is tapped, the processing check application is activated, and transition to the set processing status check icon (small) transition destination is made”.

The fifth row of the icon management table 1300, in relation to the running (printing) state 1260, displays the copy icon 1350, and a processing status check icon (small) 1366, and indicates that “the copy application is activated when the copy icon 1350 is tapped” and “when the processing status check icon (small) 1366 of the processing check application is tapped, the processing check application is activated, and transition to the set processing status check icon (small) transition destination is made”.

In the above described exemplary embodiment, the following processings may be performed.

### <A> First Modification

For example, in some cases, a user who uses a copy application wants to know whether a copy function may be immediately used, and an output result may be obtained.

In the above described example, in a state where a processing of a copy application is not present, a processing status check icon (small) is not displayed. However, when a print module is used in a processing of a print application, a processing using the copy application may be scheduled, but it is not possible to immediately obtain an output result.

Therefore, a setting is prepared in which the processing status check icon (small) may be displayed in an activation stand-by state of the processing according to the setting. The processing status check icon (small) is displayed at a timing when in using one application, the result may not be immediately obtained because another application is using the same function.

For example, when a print processing is using the print module, even if there is no copy processing, the processing status check icon (small) is displayed while added to an icon of the copy application.

Here, examples of a target function may include a print function, a scan function, a communication function (or a telephone line), and a transfer function (or a network).

### <B> Second Modification

There is a case where after a processing is started, immediate cancellation is desired. In order to cope with such a case, in a running state, a processing status check icon (small) may be selected so as to perform “immediate cancellation” or “pause as temporary stop”.

### <C> Third Modification

In the above described example, after a processing of an icon on a second page of a menu is activated, selecting a home key causes returning to a first page of the menu. Therefore, in order to select a processing status check icon (small), it is necessary to scroll to the second page.

In the case of returning to the menu by the home key after the processing is activated, a display location of a menu screen may be a location where the processing icon whose processing has just been activated is displayed, through scrolling, so that the processing status check icon (small) may be easily selected. This is an example of “perform control of returning to a location where the first icon is displayed when a predetermined key is selected”.

Meanwhile, in the case of a condition that the processing status check icon (small) is not displayed, the above control is not performed.

### <D> Fourth Modification

For some applications, one-touch applications having settings of frequently used parameters as presets may be created.

The applications and the one-touch applications are arranged as separate applications on a menu.

For example, a one-touch application is managed by an application management table 1400.

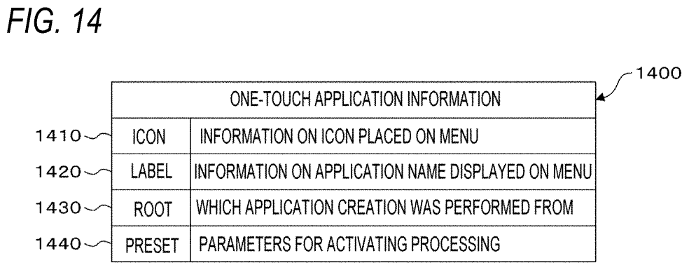

FIG. 14 is an explanatory view illustrating a data structure example of the application management table 1400. The application management table 1400 includes an icon column 1410, a label column 1420, a root column 1430, and a preset column 1440. The icon column 1410 stores information on an icon placed on the menu. The label column 1420 stores information on an application name displayed on the menu. The root column 1430 stores information on which application creation is performed from. The preset column 1440 stores parameters for activating a processing.

Since plural one-touch applications may be registered, and their icons may be disposed on the menu screen, in some cases, due to displaying of many one-touch applications, the user may need to search for a desired one-touch application. Therefore, even when a processing status check icon (small) is used, searching may be necessary.

In many cases, the user who uses the one-touch application is conscious of “a copy of the one-touch application is used”, and recognizes a root application (in this case, an original copy application). Since the root application is used by many users, the icon of the root application is often disposed at a place that is easy to access, in a home menu. Therefore, searching for the icon of the root application is likely to be easy.

Thus, in the case of the immediate processing non-executable state 1230 illustrated in the example of FIG. 12, when “processing list 5” or “processing list 6” in the processing status check icon function table 1000 illustrated in the example of FIG. 10 is set in the setting for displaying the processing status check icon (small), the processing status check icon (small) is also displayed on the icon of the root application. Therefore, it becomes easy to select the processing status check icon (small) added to the easy-to-find root application icon.

The processing status check icon function table 1000 may be a processing status check icon function table 1500.

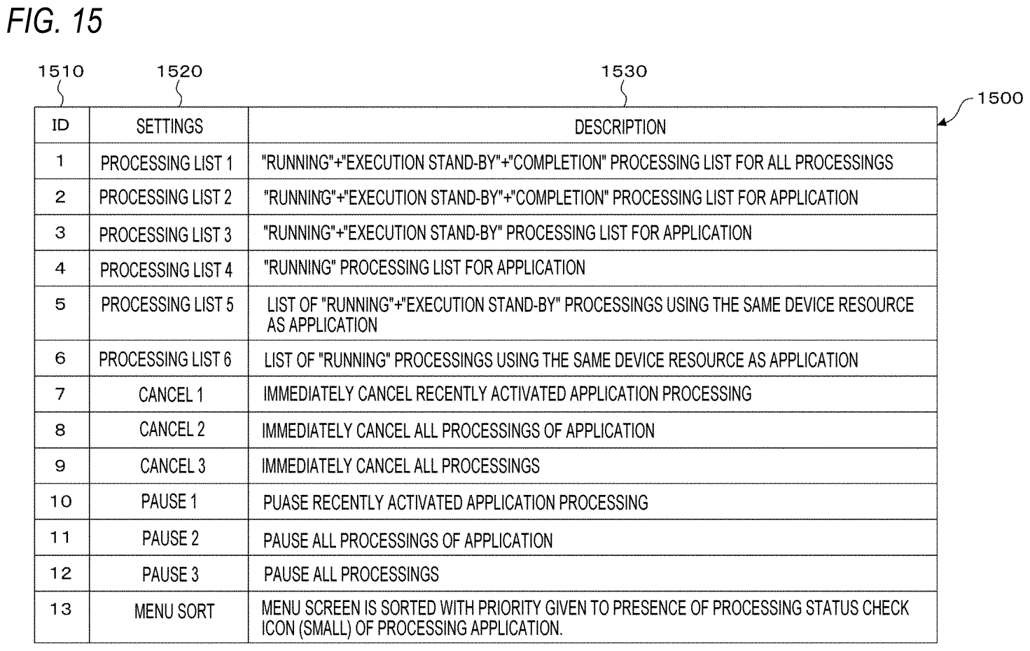

FIG. 15 is an explanatory view illustrating a data structure example of the processing status check icon function table 1500. The processing status check icon function table 1500 includes an ID column 1510, a setting column 1520, and a description column 1530. The ID column 1510 stores IDs. The setting column 1520 stores settings. The description column 1530 stores descriptions of the settings. The processing status check icon function table 1500 is obtained by adding the thirteenth row ID:13 to the processing status check icon function table 1000.

In the processing status check icon function table 1500, the thirteenth row indicates that ID:13 is set to “menu sort”, and the description is “menu screen is sorted with priority given to presence of processing status check icon (small) of processing application”.

Therefore, in the setting table 400 or the setting table 1100, “13: menu sort” may be set in a transition destination column of the processing status check icon (small) (the processing status check icon (small) transition destination 450 or the operation/processing contents 1160).

In a case where such a setting is made, when the processing status check icon (small) is selected, on a first page of the menu screen, in order from the top left, arrangement is made through sorting in the order in which processing status check icons (small) are displayed.

The priority order among applications on which the processing status check icons (small) are displayed is as follows. (A) An icon of a running processing with a processing status check icon (small) is set as the first priority. (B) An icon of an execution stand-by processing with a processing status check icon (small) is set as the second priority. (C) An icon of another processing with a processing status check icon (small) is set as the third priority. (D) An icon of a processing without a processing status check icon (small) is set as the fourth priority.

When there are plural target icons in each priority, the followings are made. In a case where there are plural (A)'s, in the order in which processings are activated. In a case where there are plural (B)'s, according to the scheduling order of processings. That is, the earlier the order, the higher the priority. In a case where there are plural (C)'s, according to the order of arrangement prior to menu sorting. In a case where there are plural (D)'s, according to the order of arrangement prior to menu sorting.

The timing for returning the sorting to the original state (that is, canceling) is when auto clearing, or transition to a screen other than the home menu is made.

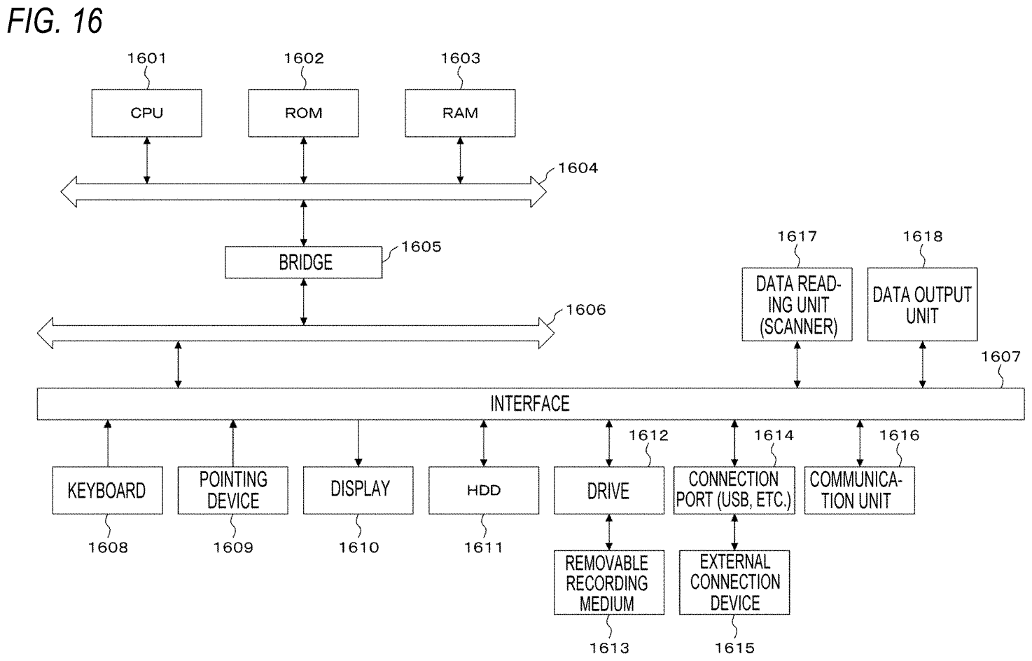

A hardware configuration example of the information processing apparatus 100 of the exemplary embodiment will be described with reference to FIG. 16. The configuration illustrated in FIG. 16 is implemented by, for example, a personal computer, and illustrates a hardware configuration example including a data reading unit 1617 such as a scanner, and a data output unit 1618 such as a printer.

A central processing unit (CPU) 1601 is a controller that executes a processing according to a computer program that describes an execution sequence of each of various modules described in the above described exemplary embodiment, that is, the operation accepting module 105, the processing module 110, the display control module 115, the display module 120, and the like.

A read only memory (ROM) 1602 stores programs, operation parameters or the like used by the CPU 1601. A random access memory (RAM) 1603 stores programs used in the execution of the CPU 1601, parameters that properly vary in the execution, or the like. These are connected to each other via a host bus 1604 including a CPU bus or the like.

The host bus 1604 is connected to an external bus 1606 such as a peripheral component interconnect/interface (PCI) bus via a bridge 1605.

A keyboard 1608, and a pointing device 1609 such as a mouse are devices operated by an operator. A display 1610 may include a liquid crystal display device, a cathode ray tube (CRT), or the like, and displays various information as text or image information. The display 1610 may be a touch screen which has both functions of the pointing device 1609 and the display 1610. In such a case, in the implementation of a keyboard function, unlike the physically connected keyboard 1608, a keyboard (also referred to as a so-called software keyboard, a screen keyboard, or the like) may be drawn on a screen (for example, a touch screen) by software so as to implement the keyboard function.

A hard disk drive (HDD) 1611 incorporates a hard disk (that may be a flash memory or the like besides the hard disk), and drives the hard disk to record or reproduce information or programs to be executed by the CPU 1601. The HDD 1611 stores accepted operation data, data required for processings of the processing module 110, the setting table 400, the icon management table 500, and the like. Further, other various data, various computer programs, and the like are stored.

A drive 1612 reads data or programs recorded on a mounted removable recording medium 1613 such as a magnetic disk, an optical disc, a magnetooptical disc, or a semiconductor memory, and supplies the data or the programs to the RAM 1603 connected via an interface 1607, the external bus 1606, the bridge 1605, and the host bus 1604. The removable recording medium 1613 may also be used as a data recording area.

A connection port 1614 is a port by which an external connection device 1615 is connected, and has a connection unit such as USB or IEEE 1394. The connection port 1614 is connected to the CPU 1601 and the like via the interface 1607, the external bus 1606, the bridge 1605, the host bus 1604, and the like. A communication unit 1616 is connected to a communication line, and executes a processing of a data communication with the outside. The data reading unit 1617 is, for example, a scanner, and executes a read processing of a document. The data output unit 1618 is, for example, a printer, and executes an output processing of document data.

In the above described exemplary embodiment, regarding one by a computer program, the computer program as software is read by a system of the present hardware configuration, and then the software cooperates with hardware resources so as to implement the above described exemplary embodiment.

The hardware configuration of the information processing apparatus 100, which is illustrated in FIG. 16, illustrates one configuration example, and the exemplary embodiment is not limited to the configuration illustrated in FIG. 16 as long as a configuration where modules described in the exemplary embodiment are executable is employed. For example, a graphics processing unit (GPU, including general-purpose computing on graphics processing units (GPGPU)) may be used as a processor, some modules may include dedicated hardware (a specific example includes an application specific integrated circuit (ASIC) or the like) or reconfigurable integrated circuits (a specific example includes a field-programmable gate array (FPGA) or the like), some modules may be provided in the external system connected through a communication line, or plural systems illustrated in FIG. 16 may be connected to each other through a communication line so as to cooperate with each other. In particular, the configuration may be incorporated into a portable information communication device (the portable information communication device includes a cellular phone, a smartphone, a mobile device, a wearable computer and the like), information appliances, a robot, a copier, a facsimile, a scanner, a printer, a multifunction device (the multifunction device is an image processing device having two or more among functions of a scanner, a printer, a copier, a facsimile and the like) or the like as well as the personal computer.

The described program may be provided while being stored in a recording medium, or may be provided via a communication unit. In such a case, for example, the above described program may be regarded as an invention of a “computer-readable recording medium having a program recorded therein”.

The “computer-readable recording medium having a program recorded therein” refers to a computer-readable recording medium having a program recorded therein, which is used for installing, executing, and distributing the program.

Examples of the recording medium may include a digital versatile disc (DVD), e.g., “DVD-R, DVD-RW, DVD-RAM, etc.” which are standards established in a DVD forum, and e.g., “DVD+R, DVD+RW, etc.” which are standards established in DVD+RW, a compact disc (CD), e.g., a read-only memory (CD-ROM), a CD recordable (CD-R), a CD rewritable (CD-RW), etc., a Blu-ray disc (registered trademark), a magnetooptical disc (MO), a flexible disc (FD), a magnetic tape, a hard disk, a read-only memory (ROM), an electrically erasable programmable read only memory (EEPROM (register trademark)), a flash memory, a random access memory (RAM), a secure digital (SD) memory card and the like.

Then, the whole or a part of the above program may be stored or distributed while being recorded in the above recording medium. The program may be transmitted through a communication, for example, using a wired network or a wireless communication network used for a local area network (LAN), a metropolitan area network (MAN), a wide area network (WAN), the Internet, an intranet, an extranet and the like, or using a transmission medium having a combination of these. Also, the program may be carried on a carrier wave.

The above program may be a part or the whole of another program, or may be recorded in a recording medium together with a separate program. The program may be dividedly recorded in plural recording media. The program may be recorded in any manner such as compression or encryption, as long as the program may be restorable.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a display controller configured, when a first icon is selected, to control a display device to display a second icon for displaying a status of a processing corresponding to the first icon, in an area of the first icon.

2. The information processing apparatus according to claim 1, wherein when the processing is in a stand-by state and the second icon is selected, the display controller performs control so as to display a list of processings a device has.

3. The information processing apparatus according to claim 1, wherein when the processing is in a stand-by state, the display controller performs control so as not to display the second icon.

4. The information processing apparatus according to claim 1, wherein the display controller performs control such that a display form of the second icon when the processing is running is different from that when the processing is in a stand-by state.

5. The information processing apparatus according to claim 1, wherein the display controller performs control so as to display the second icon in an area of a third icon corresponding to another processing having the same function as a function of the processing corresponding to the first icon, as well as the area of the first icon.

6. The information processing apparatus according to claim 1, wherein when the second icon is selected, the display controller performs control so as to display a list of processings that use the same function as the processing corresponding to the first icon.

7. The information processing apparatus according to claim 1, wherein the display controller changes contents to be displayed when the second icon is selected, according to a method of selecting the second icon.

8. The information processing apparatus according to claim 7, wherein the display controller changes the contents to be displayed when the second icon is selected, according to the status of the processing.

9. The information processing apparatus according to claim 1, wherein when a predetermined key is selected, the display controller performs control of returning to a location where the first icon is displayed.

10. The information processing apparatus according to claim 1, wherein
the first icon corresponds to the processing in which a predetermined value is set by a user, and
the display controller performs control so as to display the second icon in an area of a third icon as a source of the processing in addition to the area of the first icon.

11. The information processing apparatus according to claim 1, wherein the display controller preferentially displays the first icon on which the second icon is displayed, on a display screen.

12. The information processing apparatus according to claim 11, wherein when there is a plurality of the first icons, the first icons are sorted and displayed according to statuses of processings corresponding to the first icons.

13. A non-transitory computer readable medium storing a program that causes a computer to execute information processing, the information processing comprising:
when a first icon is selected, controlling a display device to display a second icon for displaying a status of a processing corresponding to the first icon, in an area of the first icon.

14. An information processing apparatus comprising:
display control means for, when a first icon is selected, controlling a display device to display a second icon for displaying a status of a processing corresponding to the first icon, in an area of the first icon.
